(19) United States
(12) Patent Application Publication
(10) Pub. No.: US 2023/0301333 A1
(43) Pub. Date: Sep. 28, 2023

(54) TOFU DOUGH CUTTING DEVICE AND METHOD FOR PRODUCING DEEP-FRIED TOFU USING SAME

(71) Applicant: TAKAI TOFU & SOYMILK EQUIPMENT CO., Ishikawa (JP)

(72) Inventor: Toichiro TAKAI, Ishikawa (JP)

(73) Assignee: TAKAI TOFU & SOYMILK EQUIPMENT CO., Ishikawa (JP)

(21) Appl. No.: 18/041,511

(22) PCT Filed: Aug. 11, 2021
(86) PCT No.: PCT/JP2021/029690

§ 371 Date: Feb. 13, 2023

(30) Foreign Application Priority Data
Aug. 14, 2020 (JP) 2020-136999

(51) Int. Cl. A23L 11/45; B26D 7/18; B26D 7/06; B26D 9/00

(52) U.S. Cl. CPC A23L 11/45; B26D 7/1845; B26D 7/0625; B26D 9/00; B26D 2007/0018

(57) ABSTRACT

The tofu dough cutting device includes a cutting section. The cutting section includes: a first cutting section including a lateral cutting blade configured to cut the sheet-shaped tofu dough in a direction perpendicular to a conveying direction of the sheet-shaped tofu dough; and a second cutting section including a composite cutting blade in which a longitudinal cutting blade and a corner portion cutting blade are integrated. The longitudinal cutting blade is configured to cut the tofu dough in a same direction as the conveying direction. The corner portion cutting blade is provided at least at one end portion of the longitudinal cutting blade and configured to chamfer the corner portion.

### TECHNICAL FIELD

The present invention relates to a tofu dough cutting device for producing deep-fried tofu such as hand-made deep-fried tofu, thin deep-fried tofu, thick deep-fried tofu, or tofu cutlets, and a method for producing deep-fried tofu using the same.

### BACKGROUND ART

In related art, in consideration of good appearance and food texture, it has been variously devised to cut corner portions of deep-fried tofu for Inari-sushi (vinegared sushi rice in a sweetened fried tofu pouch) into a round shape or an oblique shape (for example, see Patent Literature 1 to 3).

For example, a method for producing deep-fried tofu as disclosed in Patent Literature 1 includes: cutting a continuously conveyed sheet-shaped dough for deep-fried tofu into a plurality of rows and columns; punching sections corresponding to corners into a substantially rectangular shape by a punching blade; and removing punched columnar offcuts by suction.

According to Patent Literature 2, it is known to attach a shaping plate to the inner side of a frying frame of a fryer. The shaping plate is for rounding corner portions of deep-fried tofu, or for obliquely cutting corner portions of a tofu dough in advance so that the corner portions of the tofu dough are rounded when fried and puffed. The tofu dough is put in the frying frame and is heated and puffed in an oil tank, so that the deep-fried tofu is shaped with round corner portions.

Patent Literature 3 discloses a deep-fried tofu in which corners of a tofu dough are rounded or cut at about 45°.

Patent Literature 4 to 6 disclose a regeneration-production method for dough for deep-fried tofu, which is for recycling a defective tofu dough generated when producing deep-fried tofu. By improving a regeneration step after collecting the defective tofu dough, the storability of a final product is improved, and the capability of treating regenerable defective tofu doughs is greatly improved.

### CITATION LIST

### Patent Literature

Patent Literature 1: JP6412441B2

Patent Literature 2: JPH11-169302A

Patent Literature 3: JP3017507U

Patent Literature 4: JP4789736B2

Patent Literature 5: JP5604364B2

Patent Literature 6: JP5750678B2

### SUMMARY OF INVENTION

### Technical Problem

Incidentally, Patent Literature 1 discloses that the lateral cutting blade sections may couple the punching blade sections to each other, and the lateral cutting and the punching of the corner portions may be performed simultaneously. In this case, a component having a large number of punching blade sections is required for the lateral cutting blade section. Such component is a special component requiring welding, and is difficult to achieve dimensional accuracy, which increases the cost. In addition, the dough for deep-fried tofu tends to vary on a daily basis depending on the quality of soybeans and oil, and it is necessary to finely adjust the cutting dimensions, or it is necessary to finely adjust the dimensions depending on product items. The component, however, is an integral component and thus cannot be finely adjusted, and requires to prepare a plurality of spare blades, which is costly.

Further, in the case where the lateral cutting blade section and the punching blade section according to Patent Literature 1 are coupled to each other, it is necessary to accurately align the laterally cut out dough for deep-fried tofu with a punching section, cut the tofu dough into pieces by using another mechanism, and distribute the pieces of dough with an increased interval. In the case where the lateral cutting blade section and the punching blade section are independent from each other, the punching section may be distorted to the left and right due to minute meandering of the conveyor belt, and the corner-cutting dimension of the tofu dough may be slightly distorted.

On the other hand, it is also desired to cut the corner portion more accurately with less variation, reuse the corner offcuts hygienically, support dimension adjustment more easily, and cut out a dough for deep-fried tofu more efficiently with high processing capacity.

In addition, Patent Literature 1 discloses removing tofu dough offcuts at corner portions punched by a punching blade section by the method of suction under reduced pressure, and picking up the punched tofu dough on a collection conveyor via suction by air, and then discharging by blowing. This requires repeated air suction and discharge, and air containing a large number of floating bacteria is suctioned in high temperature and high humidity, which may contaminate the inside of an air pipe and become a secondary contamination source. Further, in Patent Literature 1, the amount of air to be blown for discharging the tofu dough is also large. Tofu residue is likely to clog the inside of the cylinder of the punching blade, the suction section, and the like, and is difficult to observe. Therefore, long-term operation thereof is likely to lead to unhygienic conditions, and regeneration of the corner offcuts is difficult. In addition, time is required for the operation of discharging the punched tofu dough, and a cutting cycle time is required, which limits the improvement of the line ability. Further, Patent Literature 1 does not include specific description or suggestion of a unit for reusing the corner offcuts or a distribution unit or feed unit for automatically feeding the tofu dough cut out into a rectangular shape into the fryer frame. In addition, since the operation of discharging the punched tofu dough is performed above the transport line, the corner offcuts or the residue may drop, adhere to the product and fried as it is, which causes loss.

The present invention has been made in view of the problems described above, and an object of the present invention is to provide a tofu dough cutting device and a method for producing deep-fried tofu using the tofu dough cutting device, which are capable of cutting corner portions with high accuracy while increasing the capability of a continuous line and limiting the initial cost and the running cost. Another object of the present invention is to provide a tofu dough cutting device and a method for producing deep-fried tofu using the same, which can collect and recycle corner portions hygienically and easily.

### Solution to Problem

The above object of the present invention is achieved by the following configurations.

(1) A tofu dough cutting device for cutting out a substantially rectangular tofu dough for deep-fried tofu from a sheet-shaped tofu dough by chamfering a corner portion of the sheet-shaped tofu dough, the tofu dough cutting device including:

a cutting section including:
a first cutting section including a lateral cutting blade configured to cut the sheet-shaped tofu dough in a direction perpendicular to a conveying direction of the sheet-shaped tofu dough; and
a second cutting section including a composite cutting blade in which a longitudinal cutting blade and a corner portion cutting blade are integrated, the longitudinal cutting blade being configured to cut the tofu dough in a same direction as the conveying direction, the corner portion cutting blade being provided at least at one end portion of the longitudinal cutting blade and being configured to chamfer the corner portion.

(2) A tofu dough cutting device for cutting out a substantially rectangular tofu dough for deep-fried tofu from a sheet-shaped tofu dough by chamfering a corner portion of the sheet-shaped tofu dough, the tofu dough cutting device including:

a cutting section including a composite cutting blade in which a lateral cutting blade, a longitudinal cutting blade and a corner portion cutting blade are integrated, the lateral cutting blade being configured to cut the sheet-shaped tofu dough in a direction perpendicular to a conveying direction of the sheet-shaped tofu dough, the longitudinal cutting blade being configured to cut the tofu dough in a same direction as the conveying direction, the corner portion cutting blade being configured to chamfer the corner portion.

(3) The tofu dough cutting device according to (1) or (2), further including:

a conveyor or a transfer plate configured to receive the composite cutting blade;

another conveyor or another transfer plate provided adjacent to and downstream of the conveyor or the transfer plate; and

a collection mechanism provided below a gap portion between the conveyor or the transfer plate and the another conveyor or the another transfer plate to cover at least the gap portion, the collection mechanism being configured to catch and collect an offcut piece generated when the tofu dough for deep-fried tofu is cut out from the sheet-shaped tofu dough.

(4) The tofu dough cutting device according to (3), further including:

an air-blowing unit provided above at least one of the another conveyor or the another transfer plate or a downstream side of the composite cutting blade of the conveyor, and configured to drop the offcut piece downward toward the collection mechanism.

(5) The tofu dough cutting device according to (3) or (4), further including:

a guide member provided on both side portions of the conveyor in a width direction and downstream of the composite cutting blade, the guide member being configured to drop the offcut piece downward toward the collection mechanism.

(6) The tofu dough cutting device according to (1) or (2), further including:

a conveyor configured to convey the sheet-shaped tofu dough;

a chopping board section provided adjacent to and downstream of the conveyor and configured to receive at least the composite cutting blade of the cutting section, the chopping board section having a through hole corresponding to a shape of an offcut piece generated when the substantially rectangular tofu dough is cut out from the sheet-shaped tofu dough; and

a collection mechanism provided below the chopping board section and configured to collect the offcut piece.

(7) The tofu dough cutting device according to (6),

in which the second cutting section includes a punching pin provided at a position corresponding to a position of the corner portion cutting blade and configured to discharge the offcut piece to the collection mechanism in conjunction with the corner portion cutting blade cutting the corner portion of the tofu dough.

(8) The tofu dough cutting device according to (2), further including:

a conveyor configured to convey the sheet-shaped tofu dough;

a chopping board section provided adjacent to and downstream of the conveyor and configured to receive at least the composite cutting blade of the cutting section, the chopping board section having a through hole corresponding to a shape of an offcut piece generated when the substantially rectangular tofu dough is cut out from the sheet-shaped tofu dough; and

a collection mechanism provided below the chopping board section and configured to collect the offcut piece.

(9) A tofu dough cutting device for cutting out a substantially rectangular tofu dough for deep-fried tofu from a sheet-shaped tofu dough by chamfering a corner portion of the sheet-shaped tofu dough, the tofu dough cutting device including:

a cutting section including:
a lateral cutting blade configured to cut the sheet-shaped tofu dough in a direction perpendicular to a conveying direction of the tofu dough;
a longitudinal cutting blade configured to cut the tofu dough in a same direction as the conveying direction; and
a corner portion cutting blade configured to chamfer the corner portion;

a conveyor or a transfer plate configured to receive at least the corner portion cutting blade;

another conveyor or another transfer plate provided adjacent to and downstream of the conveyor or the transfer plate; and

a collection mechanism provided below a gap portion between the conveyor or the transfer plate and the another conveyor or the another transfer plate to cover at least the gap portion, the collection mechanism being configured to collect an offcut piece generated when the tofu dough for deep-fried tofu is cut out from the sheet-shaped tofu dough.

(10) A method for producing deep-fried tofu using the tofu dough cutting device according to any one of (1) to (9), the method including:

producing a substantially rectangular tofu dough for deep-fried tofu, the tofu dough being cut out from a sheet-shaped tofu dough and having a chamfered corner portion.

### ADVANTAGEOUS EFFECTS OF INVENTION

According to the present invention, the second cutting section includes the corner portion cutting blade provided at least at one end portion of the longitudinal cutting blade and configured to chamfer the corner portion, and thus can accurately cut the corner portion while preventing variation in dimension due to meandering of the conveyor, speed unevenness, or the like, and can produce deep-fried tofu with stable dimension at low cost. In addition, by individually driving the plurality of composite cutting blades in a manner spreading in the lateral direction, the substantially rectangular tofu dough cut out into pieces can be distributed with an increased equal interval in the lateral direction.

In addition, for example, the substantially rectangular tofu dough cut out into pieces can also be distributed while being spread in the lateral direction at substantially equal intervals in a speed increase distribution type or a zigzag distribution type by transferring to another conveyor.

In addition, according to the present invention, since the composite cutting blade in which the lateral cutting blade, the longitudinal cutting blade, and the corner portion cutting blade are integrated is provided, it is possible to cut the corner portion while limiting variation in dimension and limiting production cost, and to produce deep-fried tofu with stable dimension at low cost.

Further, according to the present invention, the collection mechanism for collecting the offcut pieces generated when the substantially rectangular tofu dough is cut out from the sheet-shaped tofu dough is provided below the gap portion between the conveyor or the transfer plate and the another conveyor or the another transfer plate. Therefore, the corner portion can be collected easily and hygienically, and can be, for example, recycled, which enables production of deep-fried tofu at a low cost. In particular, as compared with the case where the corner offcuts of the tofu dough are suctioned by the punching blade section, the amount of air consumption is small, and troubles such as clogging of the inside of the cylinder of the punching blade are decreased. In addition, without repeatedly intaking the high-temperature and high-humidity indoor air in the factory and intaking floating bacteria together in a large amount, the tofu dough offcuts (corner offcuts) can be easily collected in a hygienic manner and recycled.

### BRIEF DESCRIPTION OF DRAWINGS

FIG. 1 is a flowchart illustrating steps of a method for producing deep-fried tofu according to the present invention.

FIG. 2A is a top view of a tofu dough cutter/feeder/supplier according to a first embodiment of the present invention.

FIG. 2B is a side view of the tofu dough cutter/feeder/supplier according to the first embodiment of the present invention.

FIG. 3 shows (a) to (c) which are perspective views illustrating a process of cutting and distributing by cutting blades of a second cutting section, together with a driving mechanism.

FIG. 4 shows (a) which is a perspective view illustrating the cutting blades of the second cutting section in FIGS. 2A and 2B, and (b) which is a top view of (a).

FIG. 5 shows (a) which is a top view for explaining an operation of separating tofu doughs for deep-fried tofu after cutting by the cutting blades of the second cutting section, and (b) which is a perspective view of (a).

FIG. 6 shows (a) which is a perspective view illustrating a modification of the cutting blades of the second cutting section, and (b) which is a top view of (a).

FIG. 7 shows (a) which is a top view for explaining an operation of distributing tofu doughs for deep-fried tofu after cutting by the cutting blades of the second cutting section according to the modification, and (b) which is a perspective view of (a).

FIG. 8 shows (a) which is a top view illustrating another modification of the cutting blades of the second cutting section, and (b) which is a top view illustrating still another modification of the cutting blades of the second cutting section.

FIG. 9 is a view illustrating the tofu dough cut out by cutting blades of a second cutting blade and the shape of fried and puffed deep-fried tofu.

FIG. 10 is a top view of a first modification of the tofu dough cutter/feeder/supplier according to the first embodiment.

FIG. 11 is a top view of a second modification of the tofu dough cutter/feeder/supplier according to the first embodiment.

FIG. 12 is a side view of a third modification of the tofu dough cutter/feeder/supplier according to the first embodiment.

FIG. 13 shows (a) which is a top view of a fourth modification of the tofu dough cutter/feeder/supplier of the first embodiment before cutting a sheet-shaped tofu dough, and (b) which is a side view of (a).

FIG. 14 shows (a) which is a top view of a fourth modification of the tofu dough cutter/feeder/supplier of the first embodiment, illustrating a state after cutting by a first cutting section followed by cutting and punching by a second cutting section, and (b) which is a side view of (a).

FIG. 15 shows (a) which is a top view of a fourth modification of the tofu dough cutter/feeder/supplier of the first embodiment, illustrating a state after cutting and punching by a second cutting section and conveyance of the tofu dough by the first cutting section, and (b) which is a side view of (a).

FIG. 16 is a top view of a tofu dough cutter/feeder/supplier according to a second embodiment of the present invention.

FIG. 17 shows (a) which is a perspective view illustrating a composite cutting blade of a cutting section of FIG. 16, and (b) which is a top view of (a).

FIG. 18 is a top view of a first modification of the tofu dough cutter/feeder/supplier according to the second embodiment.

FIG. 19 is a top view illustrating a composite cutting blade of a cutting section of FIG. 18.

FIG. 20 is a top view of a second modification of the tofu dough cutter/feeder/supplier according to the second embodiment.

FIG. 21 shows (a) to (d) which are top views of modifications of the composite cutting blade.

FIG. 22 is a top view of a tofu dough cutter/feeder/supplier according to a modification of the present invention.

### DESCRIPTION OF EMBODIMENTS

Hereinafter, a tofu dough cutting device and a method for producing deep-fried tofu using the same according to each embodiment of the present invention will be described in detail with reference to the drawings.

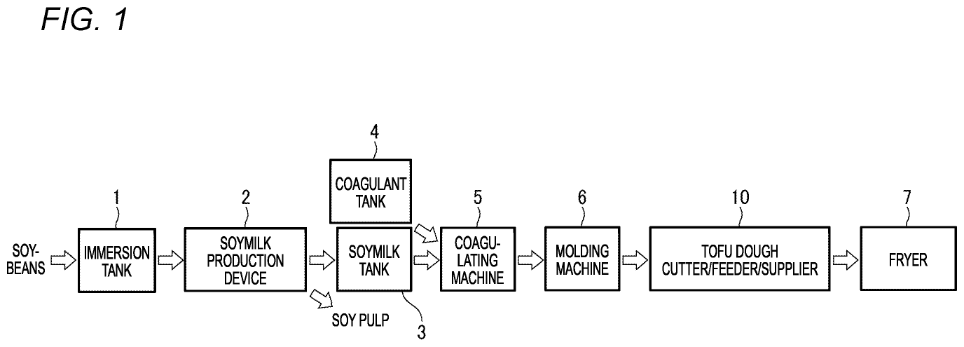

As illustrated in FIG. 1, in the method for producing deep-fried tofu, first, soybeans are immersed in water in an immersion tank 1 to be swollen. Then, the soybeans are ground into a slurry state while adding water in a soymilk production device 2, and further boiled in a steam can at 90° C. to 110° C., and cooled to 70° C. to 80° C. by adding dilution water. Thereafter, soy pulp is separated by a press machine, and the soymilk is fed to a soymilk tank 3. Then, a coagulant fed from a coagulant tank 4 is added to and mixed uniformly with the soymilk. A soymilk coagulated product is obtained by coagulation and aging in a coagulating machine 5. Thereafter, a thick soymilk coagulated product, obtained by removing a part of the liberated “supernatant” with a water extraction machine, is fed to a molding machine 6. The soymilk coagulated product is molded into a sheet-shaped soymilk dough and fed to a tofu dough cutter/feeder/supplier (cutting device) 10. In the tofu dough cutter/feeder/supplier 10, the sheet-shaped tofu dough is cut into substantially rectangular tofu doughs for deep-fried tofu. The tofu doughs have chamfered corner portions. Thereafter, for example, tofu dough for deep-fried tofu such as sushi deep-fried tofu or thin deep-fried tofu is fed to a fryer 7 and stretched in a low-temperature section (90° C. to 120° C.) (each side of the tofu dough is puffed 1.5 to 2.0 times), dried (removed of water to form a skin) in a high-temperature section (150° C. to 180° C.), and fried in an oil tank to obtain a deep-fried tofu product.

In the present embodiment, since the configuration of the tofu dough cutter/feeder/supplier 10 is improved, the description will be focused on the tofu dough cutter/feeder/supplier 10.

### First Embodiment

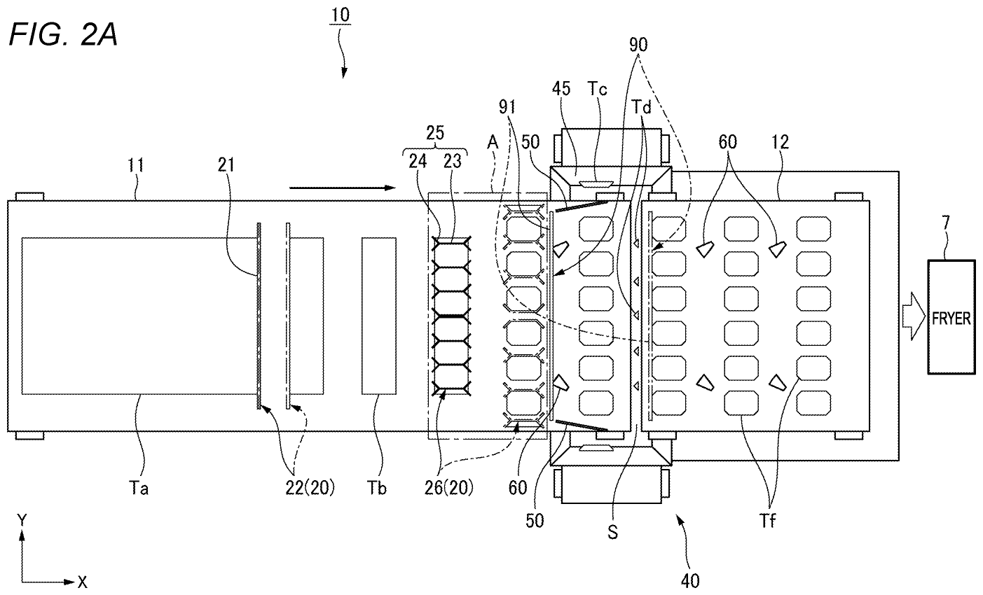

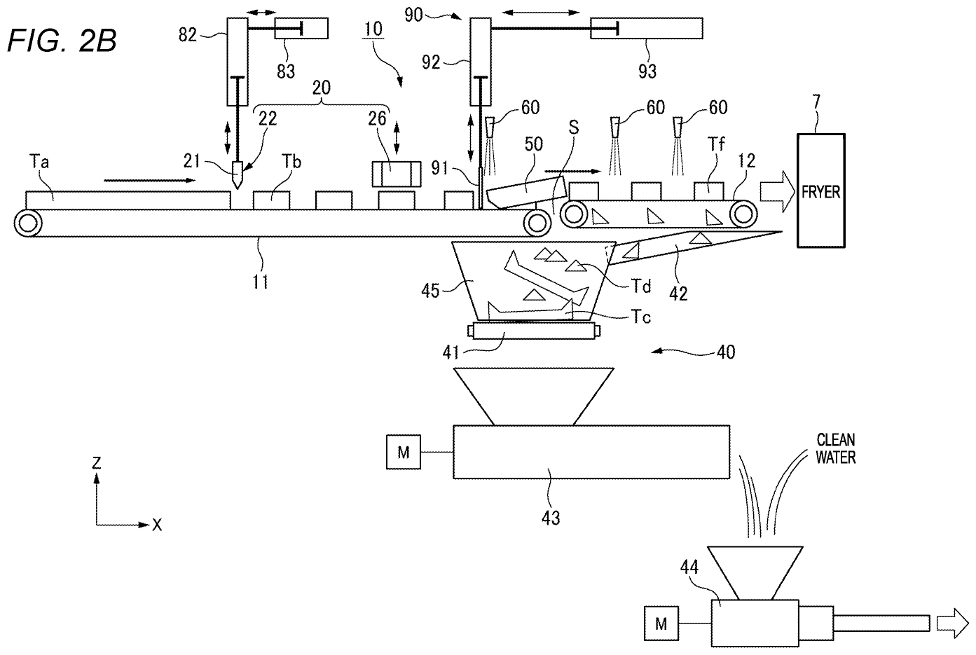

As illustrated in FIGS. 2A and 2B, the tofu dough cutter/feeder/supplier 10 according to the first embodiment mainly includes: an upstream conveyor 11 for conveying a sheet-shaped tofu dough Ta; a cutting section 20 for cutting the sheet-shaped tofu dough Ta into substantially rectangular tofu doughs Tf for deep-fried tofu, the tofu doughs Tf having chamfered corner portions; a downstream conveyor (another conveyor) 12 for conveying the tofu doughs Tf for deep-fried tofu after cutting; and a collection/recycle mechanism 40 for collecting and recycling offcut pieces Tc, Td generated when cutting out the tofu dough Tf for deep-fried tofu from the sheet-shaped tofu dough Ta.

The cutting section 20 includes a first cutting section 22 and a second cutting section 26. The first cutting section 22 includes a lateral cutting blade 21 for cutting the sheet-shaped tofu dough in a direction perpendicular to the conveying direction of the upstream conveyor 11 (the conveying direction of the sheet-shaped tofu dough Ta). The second cutting section 26 includes composite cutting blades 25 in each of which a longitudinal cutting blade 23 and corner portion cutting blades 24 are integrated. The longitudinal cutting blade 23 cuts the tofu dough in the same direction as the conveying direction of the upstream conveyor 11. The corner portion cutting blades 24 are provided at least both end portions of each longitudinal cutting blade 23, and chamfer corner portions. The first cutting section 22 is located upstream of the second cutting section 26.

In the following description, the conveying direction of the upstream conveyor 11 is also referred to as an X direction, a horizontal direction orthogonal to the conveying direction of the upstream conveyor 11 is also referred to as a Y direction, and a vertical direction perpendicular to the X direction and the Y direction is also referred to as a Z direction.

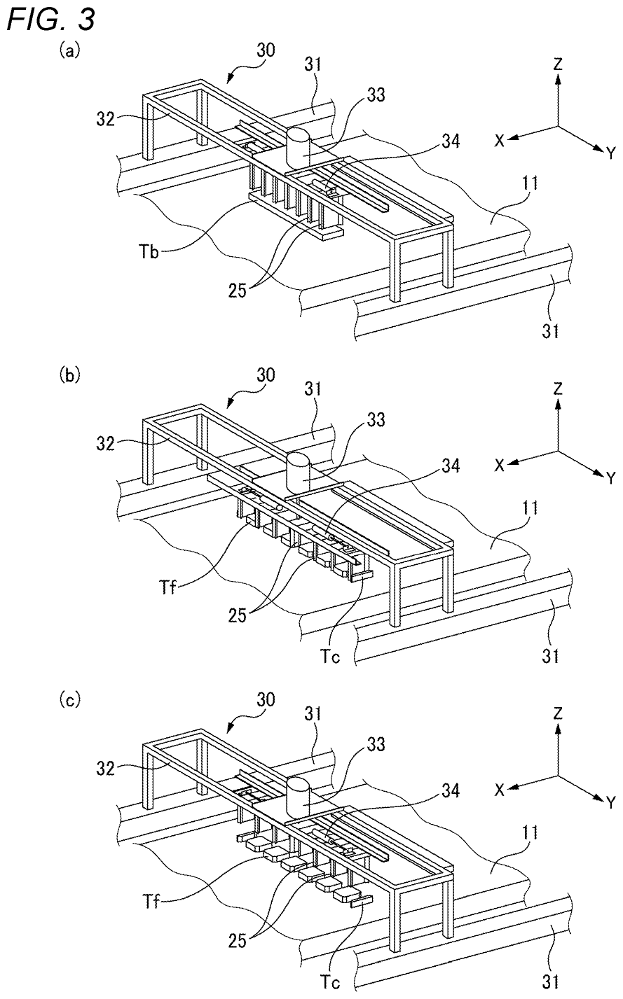

Therefore, the lateral cutting blade 21 of the first cutting section 22 can be driven up and down or back and forth by a Z-direction driving section 82 and an X-direction driving section 83 illustrated in FIG. 2B as a driving mechanism, and cuts the sheet-shaped tofu dough Ta to obtain a stripe-shaped tofu dough Tb, which is then pushed forward. The composite cutting blades 25 of the second cutting section 26 can be driven up and down by a driving mechanism 30 as illustrated in FIG. 3 and can also be driven in the Y direction. Thereby, the stripe-shaped tofu dough Tb is cut out and distributed with an increased interval in the Y direction, thereby obtaining tofu doughs Tf for deep-fried tofu.

As illustrated in FIG. 3, the driving mechanism 30 includes, on bases 31 provided on both sides of the upstream conveyor 11 in the Y direction and extending in the X direction: a frame 32 straddling the upstream conveyor 11; a pressure cylinder 33 for driving the plurality of composite cutting blades 25 in the Z direction with respect to the frame 32; and a distribution driving mechanism 34 for driving the plurality of composite cutting blades 25 in the Y direction with an increased interval in the Y direction between the tofu doughs Tf for deep-fried tofu.

The driving mechanism 30 including the pressure cylinder and the distribution driving mechanism 34 has a known configuration as described in, for example, JPH02-167047A.

The cutting of the sheet-shaped tofu dough Ta by the first cutting section 22 and the cutting of the stripe-shaped tofu dough Tb by the second cutting section may be performed in a state in which the upstream conveyor 11 temporarily stops the conveyance of the tofu doughs Ta, Tb, or in a state in which the upstream conveyor 11 continuously conveys the tofu dough Ta, such that the Tb that has been cut out is pushed forward in the X direction by a predetermined distance by the first cutting section 22 with an increased interval distance between the tofu dough Ta and the tofu dough Tb.

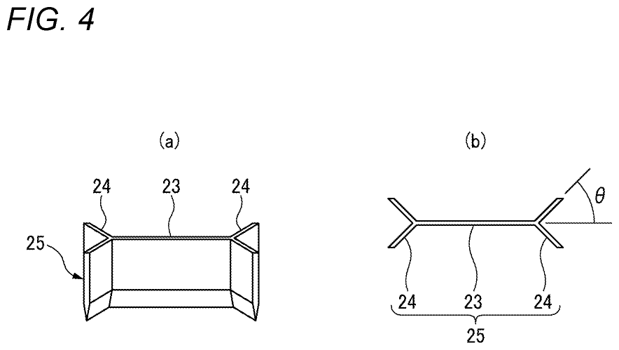

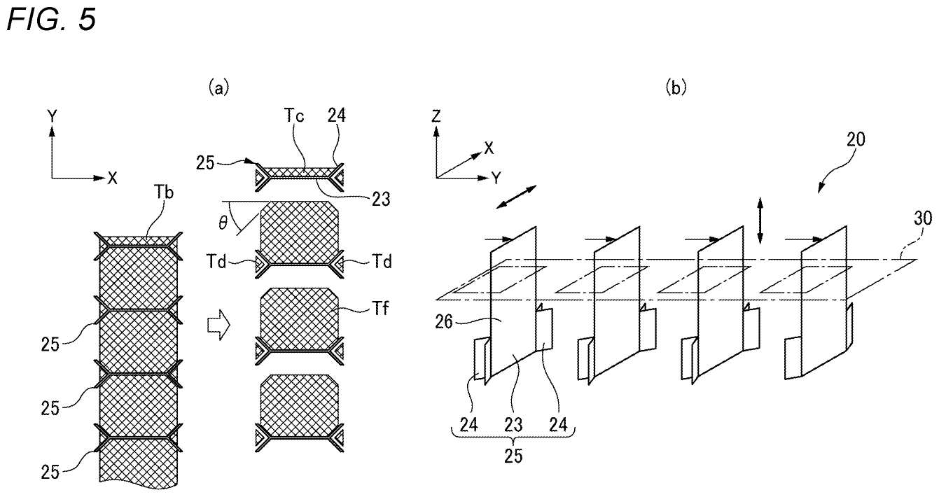

As illustrated in FIGS. 4 and 5, in the composite cutting blade 25 of the second cutting section 26, a Y-shaped blade open on both sides as the corner portion cutting blade 24 is integrated with the tip of each end portion of the longitudinal cutting blade 23 by welding to form a composite cutting blade. Therefore, when the driving mechanism 30 lowers the composite cutting blade 25, the corner portions of the tofu dough Tb are cut obliquely and linearly simultaneously with the longitudinal cutting of the tofu dough Tb. Then, the driving mechanism 30 drives the composite cutting blade 25 in the Y direction, so that the tofu doughs Tf for deep-fried tofu are arranged on the upstream conveyor 11 with an increased interval in the Y direction. As long as between both tips of each corner portion cutting blade 24, it is possible to cope with a change in the tofu dough dimension in the X direction, and a deviation of several mm in the X direction or the Y direction in the product is within an allowable range.

The driving mechanism 30 of the present embodiment cuts out and distributes the tofu doughs as illustrated in FIG. 2B without moving the tofu doughs in the X direction, and feeds the tofu doughs forward by another tofu dough feeding mechanism 90. Specifically, the other tofu dough feeding mechanism 90 includes: a Z-direction driving section 92 for moving a push-out feed plate 91 forward and backward to a feedable position; and an X-direction driving section 93 for driving the push-out feed plate 91 in the X-direction, and can drive the push-out feed plate 91 up and down or back and forth. The driving mechanism 30 may also feed the tofu dough in the X direction in parallel with the cutting out and distribution, as indicated by a region A in FIG. 2A.

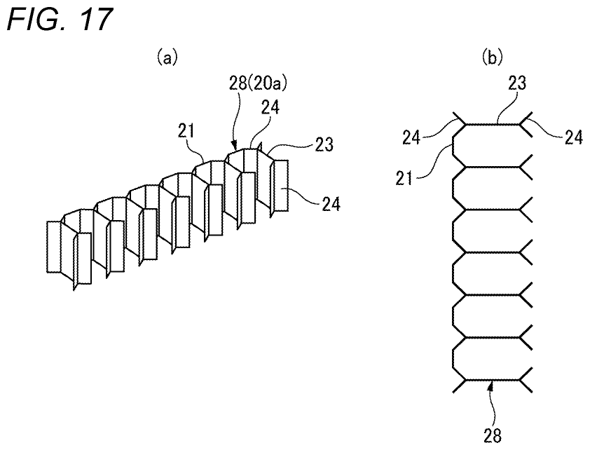

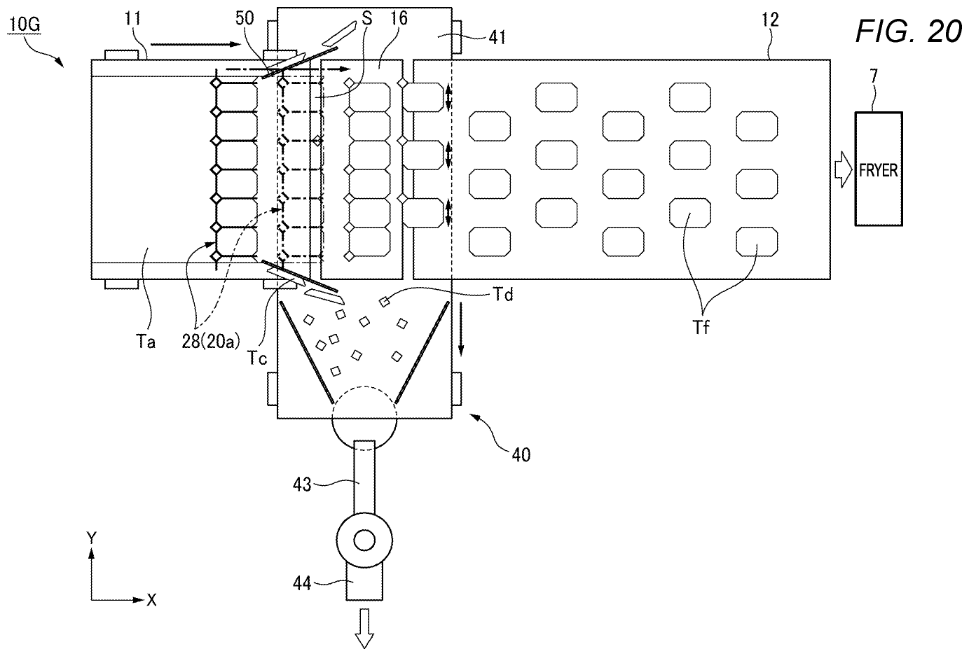

The driving mechanism 30 of the present embodiment distributes the tofu doughs Tf for deep-fried tofu normally without changing the positions thereof in the Y direction, but the present invention is not limited thereto. The plurality of tofu doughs Tf for deep-fried tofu may be arranged on the downstream conveyor 12 in a zigzag manner by moving a stopper member (not illustrated) up and down for every other tofu dough for deep-fried tofu at each distribution timing so that the tofu doughs Tf for deep-fried tofu are distributed in a manner such that the positions thereof in the X direction are separated from each other (see FIG. 20). (Regarding the zigzag distribution, refer to FIG. 17 of JP2012-140158A and FIGS. 25 to 27 of JP2019-068809A.)

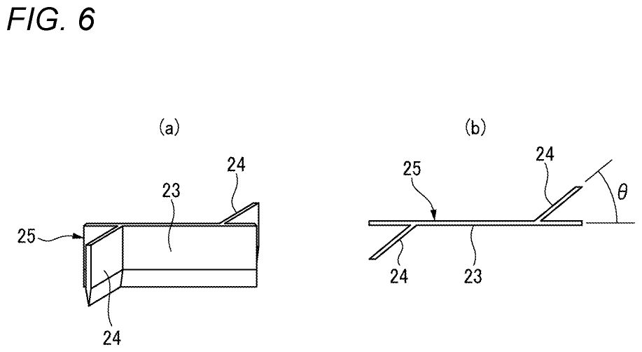

As a result, the tofu doughs Tf for deep-fried tofu are obtained in units of quires having a substantially rectangular or substantially square shape (30 mm to 200 mm on each side and 2 mm to 50 mm in thickness) in a top view. Each tofu dough Tf for deep-fried tofu is cut out to have a side length at corner portions of 5 mm to 30 mm and an angle θ (see FIGS. 4 and 6) of 30° to 60°, preferably 40° to 50°, and more preferably about 45°, and has an entire shape that is substantially rectangular and has substantially eight angles when view from the above.

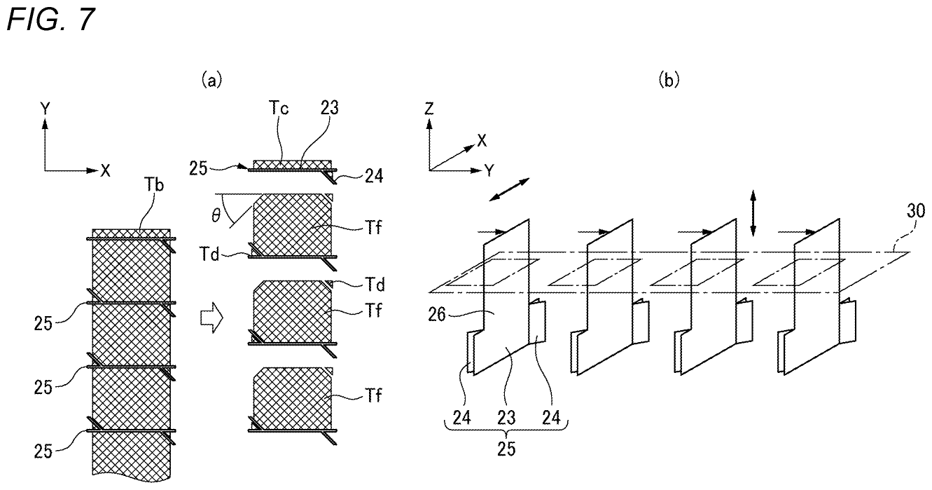

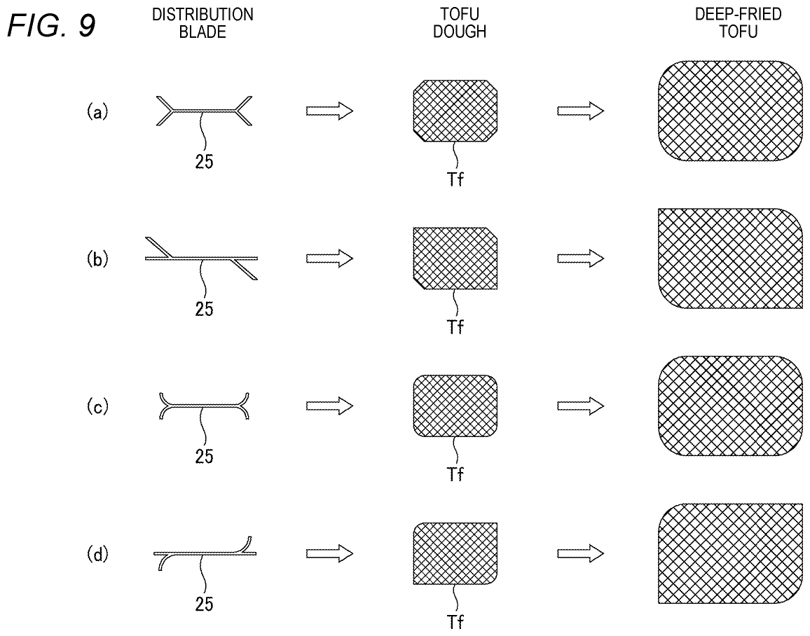

Each corner portion cutting blade 24 may be an angle blade (blade having an L-shaped cross section) welded to a position slightly away from the tip of one end portion of the longitudinal cutting blade 23, as illustrated in (b) of FIG. 6, (a) and (b) of FIG. 7, and (b) of FIG. 9.

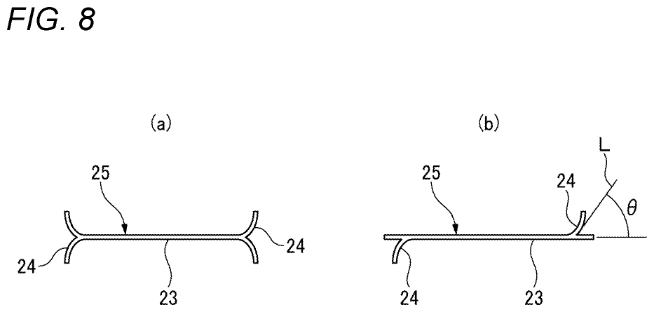

Alternatively, the corner portion cutting blade 24 may be a curved Y-shaped blade open on both sides at the tip of each end portion of the longitudinal cutting blade 23 as illustrated in (a) of FIG. 8, or may be a curved angle blade welded to a position slightly away from the tip of each end portion of the longitudinal cutting blade 23 as illustrated in (b) of FIG. 8. The angle θ here is given between the direction of the longitudinal cutting blade 23 and a tangent line L of the corner portion cutting blade 24. As a result, the corner portions of the tofu doughs are obliquely cut into curved shapes, and the tofu doughs Tf for deep-fried tofu are formed to have an entire shape that is substantially rectangular and has rounded corner portions (see (c) and (d) of FIG. 9).

In the present embodiment, as illustrated in FIG. 2A, the second cutting section 26 cuts out an even number of tofu doughs Tf for deep-fried tofu from the stripe-shaped tofu dough Tb. Therefore, at the central portion in the Y direction, two composite cutting blades 25 are used, each obtained by attaching angle blades to both sides of a longitudinal cutting blade 23. Thus, the two tofu doughs Tf in the vicinity of the center are distributed in the Y direction by the two composite cutting blades 25.

When an odd number of tofu doughs Tf for deep-fried tofu are cut out from the stripe-shaped tofu dough Tb, the tofu dough Tf at the center does not need to be moved. Therefore, all the composite cutting blades, including the central part in the Y direction, can be the one as illustrated in FIGS. 4 and 5.

When any of the corner portion cutting blades 24 is used, as illustrated in FIG. 9, when the tofu dough Tf for deep-fried tofu is fried, there are no hardened corner portions due to excessive vaporization of moisture. When seasoned and made into Inari-sushi, the food texture is excellent, and the appearance is roundish and puffy.

When the substantially rectangular tofu dough Tf for deep-fried tofu having chamfered corner portions is fried by a fryer, the fryer frame may be omitted, but a square frame or a fryer frame with rounded corner portions as described in Patent Literature 3 may also be used.

The corner portion cutting blade 24 may be a pin for punching (punching pin, substantially triangular in cross section).

Here, as described above, in the present embodiment, the cutting section 20 has a small-sized composite cutting blade 25 obtained by combining the longitudinal cutting blade and the corner portion cutting blades without providing a roll cutter to the longitudinal cutting blade, which minimizes the welding, facilitates the processing, decreases the distortion, lowers the cost for finishing, facilitates the visual observation of the tofu residue, and provides better cleanability and hygienic conditions. In the case of the related art in which a large number of square pipe blades are combined with a lateral cutting blade, the processing members are special members, and thus are difficult to obtain dimensional accuracy by welding, increasing the cost. Moreover, the inside of a cylindrical punching blade is difficult to be visually observed and cleaned, and is not hygienic because of the structure of taking air in and out by suction and injection. Further, deep-fried tofu varies on a daily basis depending on the quality of soybeans and oil, and thus the cutting dimension thereof is difficult to finely adjust. In the case of the composite cutting blade of the present embodiment, however, composite cutting blades having different dimensions can be prepared in advance as long as the composite cutting blades are inexpensive, and can be exchanged as appropriate to cope with the situation. Moreover, the fixing of the blades can be easily adjusted as long as an adjustment unit including an adjustment screw is provided. In addition, a dimensional change in the X direction can be coped with without replacing the cutting blade as long as the dimensional change falls within a range between both tips of the corner portion cutting blade 24. On the other hand, the composite blades of the related art with a lateral cutting blade are basically large members having an integral structure, and are difficult to be attached with a fine adjustment unit and requires replacement of the lateral cutting composite blade per se. Spare lateral cutting composite blades need to be stocked as a plurality of spare products, requiring both a storage place and cost.

Returning to FIGS. 2A and 2B, the downstream conveyor 12 is provided adjacent to and downstream of the upstream conveyor 11, an conveys the tofu doughs Tf for deep-fried tofu after cutting toward the fryer 7, thereby feeding the tofu doughs Tf one by one into each section of the fryer frame by a feeder (not illustrated).

The collection/recycle mechanism 40 collects and recycles the offcut pieces Tc, Td generated when the tofu doughs Tf for deep-fried tofu are cut out from the sheet-shaped tofu dough Ta. The collection/recycle mechanism 40 includes: a hopper 45 and a collection conveyor 41 provided below a gap portion S between the upstream conveyor 11 and the downstream conveyor 12 (a gap in which the tofu doughs do not drop but the corner offcut pieces are likely to drop) to cover the gap portion S at least from below; an inclined base 42 for feeding the offcut pieces Td dropped from the side of the downstream conveyor 12 to the hopper 45 and the collection conveyor 41; a cutting device 43 for cutting the offcut pieces Tc, Td collected by the collection conveyor 41; and a stirring/supplying device 44 for supplying tofu dough recycle liquid obtained by stirring the cut-out tofu dough while adding water to a predetermined step (for example, a coagulation/stirring unit of a coagulation device) to be recycled. The hopper 45 is wider than the width of the upstream conveyor 11 in the Y direction. The lower portion of the hopper 45 is open, and the offcut pieces Tc, Td collected by the hopper 45 drop onto the collection conveyor 41. A plurality of the hoppers 45 and the inclined bases 42 are appropriately arranged to catch offcut pieces dropped from various places.

Guide members (scrapers) 50 are provided on both side portions of the upstream conveyor 11 in the width direction and downstream of the composite cutting blade 25. The guide members drop the oblong tofu dough offcut pieces Tc downward toward the hopper 45. Each guide member 50 is disposed close to the upper surface of the conveyor belt of the upstream conveyor 11, and is inclined outward in the width direction of the upstream conveyor 11 as downstream of the upstream conveyor 11.

A plurality of air-blowing units (air flashes) 60 are appropriately provided downstream of the composite cutting blade 25 of the upstream conveyor 11 and above the downstream conveyor 12. The air-blowing units 60 drop the triangular tofu dough offcut pieces Td at the corner portions downward toward the hopper 45 and the inclined base 42.

As a result, the oblong tofu dough offcut pieces Tc are dropped into the hopper 45 by the guide members 50, and the triangular tofu dough offcut pieces Td are dropped from the sides of the upstream conveyor 11 and from the gap portion S between the upstream conveyor 11 and the downstream conveyor 12 by the air-blowing units 60. Further, the triangular tofu dough offcut pieces Td conveyed to the downstream conveyor 12 beyond the gap portion S without dropping from the gap portion S are dropped onto the inclined base 42 from the sides of the downstream conveyor 12 by the air-blowing units 60. In particular, the air-blowing units 60 can also separate the offcut pieces Td attached to the tofu dough Tf for deep-fried tofu from the tofu dough Tf.

In addition, the air-blowing units 60 may blow air to the offcut pieces Td detected by a camera sensor (not illustrated) and drop the offcut pieces Td onto the inclined base 42.

The inclined base 42 covers the side of the Y-direction end portion of the downstream conveyor 12 and is inclined such that the side closer to the fryer 7 is higher than the side closer to the hopper 45, and feeds the dropped triangular tofu dough offcut pieces Td to the collection conveyor 41 provided below the hopper 45. The collection conveyor 41 conveys the dropped offcut pieces Tc, Td toward the cutting device 43 in the Y direction.

Then, in the cutting device 43, the offcut pieces Tc, Td are granulated. The offcut pieces Tc, Td are preferably crushed for the purpose of preventing introduction of air, but may be finely cut without being crushed as in a grinder or the like. In addition, the cutting device 43 perform in-liquid grinding in which fine grinding is performed in liquid. As the in-liquid grinding device, a device for supplying a solid raw material such as soybean and a liquid raw material to a grinding unit and grinding the solid raw material and the liquid raw material has already been developed. Such a device, a pump mill, or the like is used to prevent introduction of air. As the cutting device 43, a colloid mill, a high-pressure homogenizer, a vacuum juicer/mixer, a vacuum/decompression food cutter, a mincing machine (uniaxial kneading machine), a biaxial extruder (biaxial kneading machine), or the like can also be used.

In the stirring/supplying device 44, stirring is performed until uniform with or without adding water in the stirring tank. In addition to water (purified water, soft water, or the like), as a method for effectively using hot water (supernatant) dehydrated and discharged in a forming process by pressing for water addition in a recycled liquid, a coagulant component remains in the “supernatant”, and the amount of coagulant can be reduced when a new dough for deep-fried tofu is produced next time. It has been found that instead of such hot water (supernatant), use of water (hot water of 100° C. or lower is also acceptable, hot water of 60° C. to 80° C. is preferable, and treatment is preferably performed at 60° C. for 30 minutes or more, or 80° C. for 10 minutes or more, which are low-temperature sterilization conditions; or alternatively, relatively warm water (about 40° C. to 50° C.)) is also preferable in terms of products. The amount of water to be added is preferably about 3 to 10 times the amount of tofu dough offcuts together with the solid content of soymilk. When the solid content of the tofu dough is 25 wt % (the moisture content of the tofu dough is 75 wt %) and the solid content of the soymilk is 3 to 5 wt %, water addition of approximately 5 to 8 times is suitable. The recycled liquid (soymilk-like solution) obtained by the recycle is fed by a pump. Bacteria forming heat-resistant spores adhering to soybeans may survive in the recycled liquid, and when the dough for deep-fried tofu is recycled to be used, the storage stability of the final product has become one problem. Therefore, by heating the recycled liquid of the dough for deep-fried tofu, various bacteria of nutritional cells other than spores can be sterilized, and the storability of the final product can be improved when the recycled liquid is used. As a result, the offcut pieces Tc, Td dropped downward are collected hygienically, recycled as a tofu dough material, and fed to the soymilk tank 3 or the coagulating machine 5 (the tofu dough recycled liquid is measured simultaneously with the soymilk measurement, air is dispersed and mixed as appropriate, and the mixture is coagulated with the coagulant).

The interval of the gap portion S between the upstream and downstream conveyors 11 and 12 is adjusted such that the offcut pieces Tc can easily drop from the gap portion S and the tofu dough Tf can be transferred without dropping. In addition, the transfer between the upstream and downstream conveyors 11 and 12 may be horizontal, but making the height of the downstream conveyor 12 slightly higher than that of the upstream conveyor 11 is also effective in transferring the tofu dough and dropping only the offcut pieces Tc downward.

The conveying speed of the downstream conveyor 12 is preferably higher than the conveying speed of the first conveyor 11. As a result, when the tofu dough is transferred, the interval in the X direction of the tofu doughs is increased at equal intervals and the substantially triangular corner offcuts are separated and easily removed by the speed difference distribution method.

When the belt width of the downstream conveyor 12 in the Y direction is set to be equal to or less than the maximum width at which the tofu dough is distributed in the Y direction with the offcuts at both end portions being removed, the substantially triangular tofu dough offcut pieces Td can be easily dropped from the sides of the conveyors 11 and 12 by using the guide members 50 and the air-blowing units 60 together.

Therefore, according to the tofu dough cutter/feeder/supplier 10 of the present embodiment, the plurality of composite cutting blades 25 in which the longitudinal cutting blades 23 and the corner portion cutting blades 24 are integrated can cut the corner portions while preventing variations in dimension, can cope with changes in dimension to some degree, and can produce deep-fried tofu with stable dimension at low cost. In addition, the tofu dough Tf for deep-fried tofu cut out by using the plurality of composite cutting blades 25 can be efficiently distributed in the Y direction. By including the plural sets of composite cutting blades 25 in the X direction, the processing capability is multiplied, and the running cost is reduced. Without the step of moving the offcut pieces, the processing capability can be enhanced as compared with the related art.

Further, according to the tofu dough cutter/feeder/supplier 10 of the present embodiment, the collection/recycle mechanism 40 for collecting and recycling the offcut pieces Tc, Td generated when the substantially rectangular tofu dough Tf is cut out from the sheet-shaped tofu dough Ta is provided below the gap portion S between the upstream conveyor 11 and the downstream conveyor 12. Therefore, the offcut pieces can be prevented from erroneously entering the fryer together with the tofu dough Tf and become defective products. The offcut pieces can be collected easily and hygienically, and can be recycled, which reduces the loss and quality problems and enables production of deep-fried tofu at a low cost.

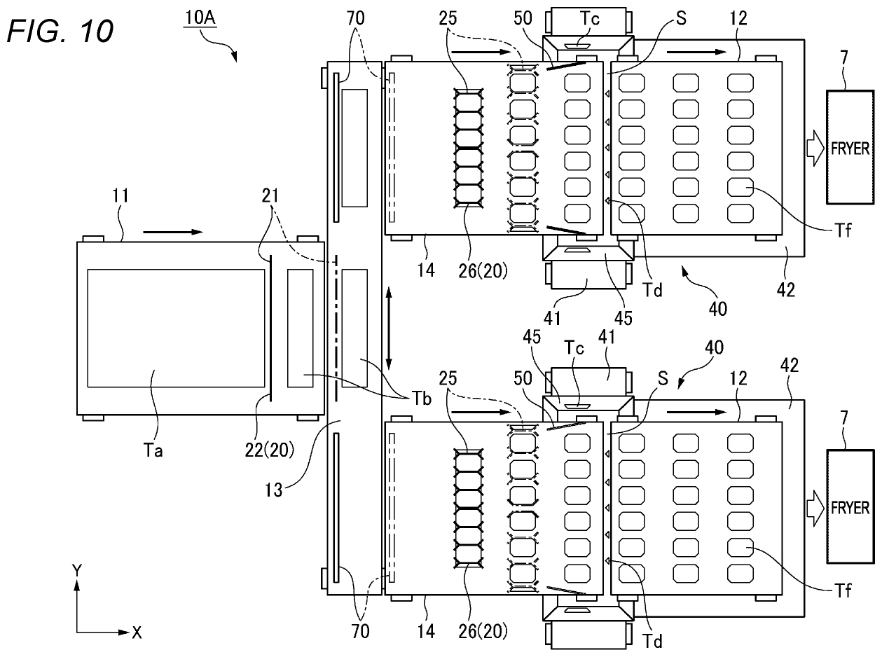

FIG. 10 shows a first modification of the tofu dough cutter/feeder/supplier according to the first embodiment. In the cutter/feeder/supplier 10A, the sheet-shaped tofu dough Ta is cut by the lateral cutting blade 21 of the first cutting section 22 on the upstream conveyor 11 to obtain the stripe-shaped tofu dough Tb. Then, the stripe-shaped tofu dough Tb is transferred by the lateral cutting blade 21 to a distribution conveyor 13 disposed adjacent to and downstream of the upstream conveyor 11. The stripe-shaped tofu doughs Tb are alternately conveyed in the Y direction by the distribution conveyor 13, and is further alternately conveyed to a pair of intermediate conveyors 14 arranged adjacent to both end portions of the distribution conveyor 13 in the Y direction. Then, on each intermediate conveyor 14, the stripe-shaped tofu dough Tb is cut into the tofu doughs Tf for deep-fried tofu and distributed at equal intervals in the Y direction by the composite cutting blade 25 of the second cutting section 26.

Therefore, in the first modification, the lateral cutting blade 21 is driven in the X direction by the X-direction driving section 83 to move the stripe-shaped tofu dough Tb from the upstream conveyor 11 to the distribution conveyor 13. Further, the cutter/feeder/supplier 10A is provided with conveyance guides 70 for moving the stripe-shaped tofu dough Tb from the distribution conveyor 13 to the respective intermediate conveyors 14.

In this case, in the collection/recycle mechanism 40 for collecting and recycling the offcut pieces Tc, Td, each hopper 45 is provided below the gap portion S between each intermediate conveyor 14 and each downstream conveyor 12 to cover at least the gap portion S.

Therefore, according to the first modification, since the cutting and distributing operation by the composite cutting blade 25, which requires a relatively long time, can be performed at two positions, it is possible to improve the work efficiency of the cutter/feeder/supplier 10A.

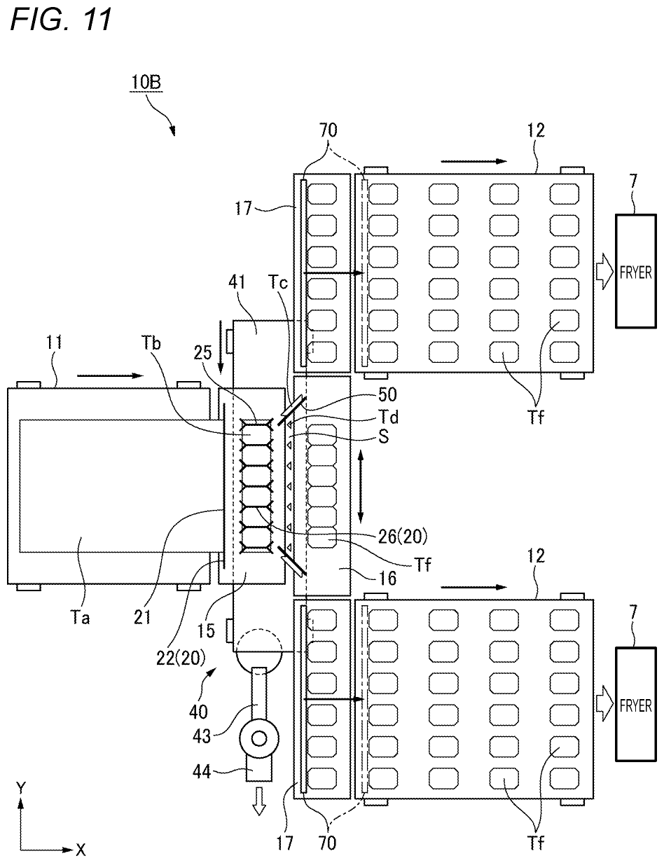

FIG. 11 shows a second modification of the tofu dough cutter/feeder/supplier according to the first embodiment. In the cutter/feeder/supplier 10B, one transfer plate 15 and one transfer conveyor 16 are arranged side by side downstream of the upstream conveyor 11 in the X direction, and two transfer conveyors 17, 17 are arranged on both sides of the transfer conveyor 16 in the Y direction.

Therefore, the lateral cutting blade 21 of the first cutting section 22 and the composite cutting blade 25 of the second cutting section 26 are disposed on the transfer plate 15. Then, the sheet-shaped tofu dough Ta is cut by the lateral cutting blade 21 of the first cutting section 22 to obtain the stripe-shaped tofu dough Tb, and then the tofu dough Tb is conveyed to a position below the composite cutting blade 25 on the transfer plate 15. Then, the stripe-shaped tofu dough Tb is cut into tofu doughs Tf for deep-fried tofu by the composite cutting blade 25 on the transfer plate 15. The composite cutting blade 25 is movable between the transfer plate 15 and the transfer conveyor 16, and conveys the tofu doughs Tf for deep-fried tofu onto the transfer conveyor 16 before the distribution in the Y direction from the state of being cut into the tofu doughs Tf for deep-fried tofu. Further, by increasing the speed from the transfer conveyor 16 to the transfer conveyor 17, the tofu doughs Tf for deep-fried tofu are distributed at predetermined intervals in the Y direction. Further, the tofu doughs Tf for deep-fried tofu are transferred from the transfer conveyor 17 to the downstream conveyor 12 to be pushed out by the guide members 70 which can be driven in the X direction.

In this case, in the collection/recycle mechanism 40 which collects and recycles the offcut pieces Tc, Td, the collection conveyor 41 is provided below the gap portion S (gap) between the transfer plate 15 and the transfer conveyor (another transfer plate) 16 to cover at least the gap portion S. The collection/recycle mechanism 40 may have a hopper as in the above embodiments.

Therefore, according to the second modification, since the tofu doughs Tf for deep-fried tofu can be supplied from two places to two fryers 7, the production capacity can be improved. Although the width in the Y direction is increased in view of the layout, the length in the X direction can be shortened and the processing capacity of the cutting and distributing step can be multiplied.

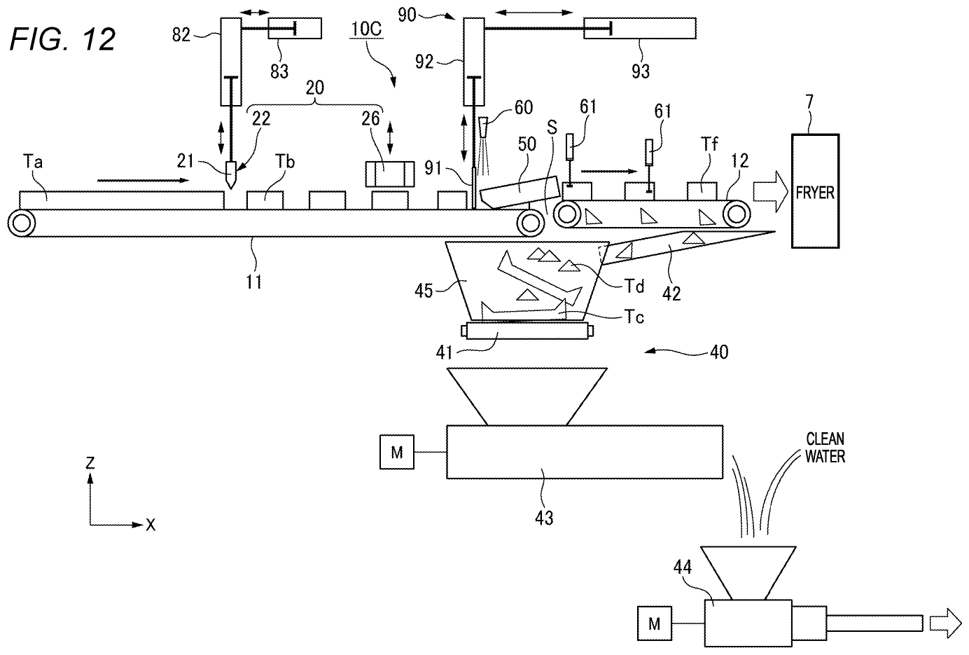

FIG. 12 shows a third modification of the tofu dough cutter/feeder/supplier according to the first embodiment. In the cutter/feeder/supplier 10C, bumping rods 61 are movably provided instead of the air-blowing units 60 on the downstream conveyor 12. As a result, the offcut pieces Td detected by an inspection camera or the like on the downstream conveyor 12 can be dropped onto the inclined base 42 by the bumping rods 61.

The means for dropping the offcut pieces Td on the conveyor is not limited to the guide members 50, the air-blowing units 60, and the bumping rods 61 described above, and a spring plate or the like may be used.

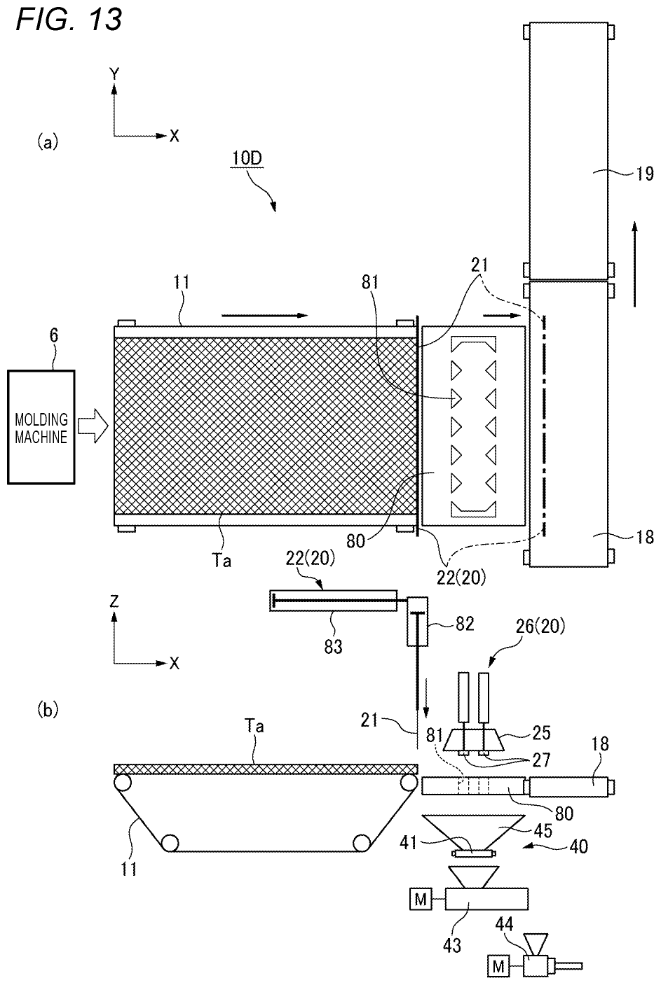

FIGS. 13 to 15 show a fourth modification of the tofu dough cutter/feeder/supplier according to the first embodiment. The cutter/feeder/supplier 10D is provided with a chopping board section (transfer plate) 80 adj acent to and downstream of the upstream conveyor 11 in the X direction, a first Y-direction conveyor 18 adjacent to the chopping board section 80 in the X direction, and a second Y-direction conveyor 19 adj acent to the first Y-direction conveyor 18 in the Y direction. The downstream conveyor 12 is disposed adjacent to and downstream of the second Y-direction conveyor 19 in the X direction, but is not illustrated in FIGS. 13 to 15.

The chopping board section 80 receives the lateral cutting blade 21 and the composite cutting blade 25 of the cutting section 20, and has a plurality of through holes 81 corresponding to the shapes of the offcut pieces Tc, Td generated upon cutting. The collection/recycle mechanism 40 for collecting and recycling the offcut pieces Tc, Td is arranged below the chopping board section 80.

The first cutting section 22 is provided with a Z-direction driving section 82 that drives the lateral cutting blade 21 up and down, and an X-direction driving section 83 that drives the up-down driving section in the X direction. The second cutting section 26 includes punching pins 27 that are provided at positions corresponding to positions of the corner portion cutting blades 24 and that discharge the offcut pieces Tc, Td to the collection/recycle mechanism 40 via the through holes 81 in conjunction with the corner portion cutting blades 24 cutting the corners of the tofu doughs.

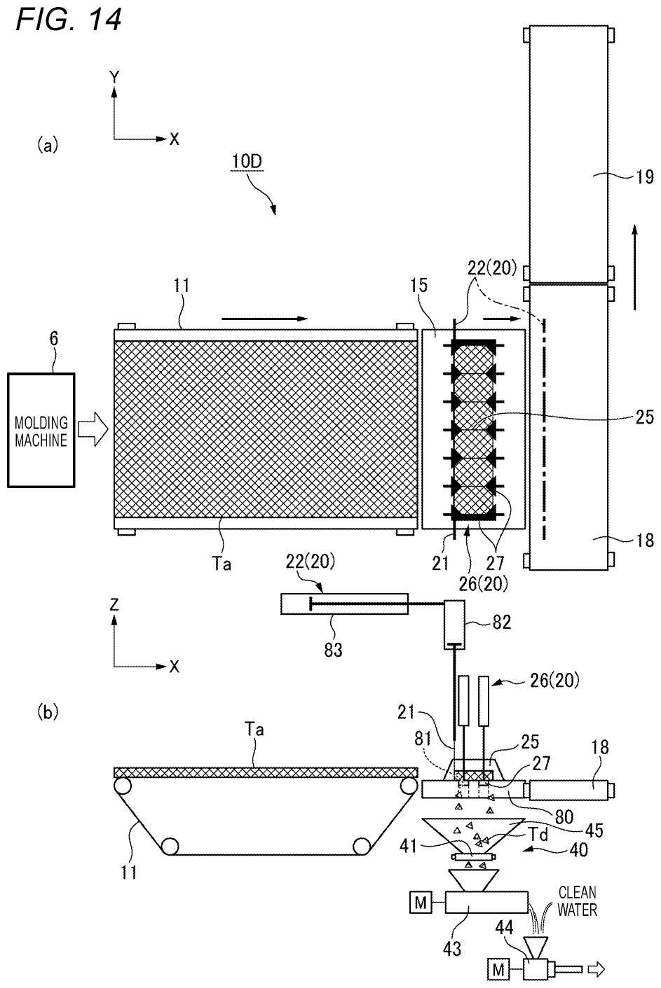

Therefore, in this modification, the stripe-shaped tofu doughs Tb cut out by the first cutting section 22 are conveyed onto the chopping board section 80 by the X-direction driving section 83. Thereafter, as illustrated in FIG. 14, the tofu doughs Tf for deep-fried tofu are cut out by the second cutting section 26. The punching pins 27 corresponding to the shapes of the offcut pieces Tc, Td are simultaneously or sequentially driven downward to pass through the through holes 81. The offcut pieces Tc, Td are discharged to the collection/recycle mechanism 40. At this time, air may be blown to completely drop the offcut pieces, or the offcut pieces may be pushed down by a punching rod to assist the drop.

The offcut pieces Tc, Td discharged to the collection/recycle mechanism 40 are collected hygienically and recycled as the tofu dough material as in the above embodiments.

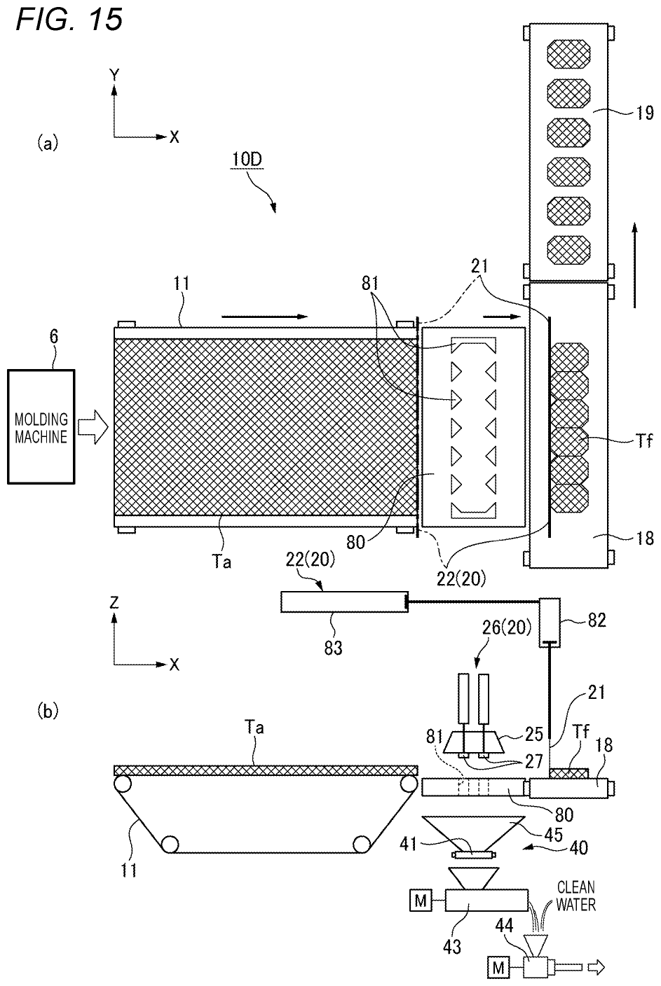

Thereafter, as illustrated in FIG. 15, the second cutting section 26 is retracted upward, and the plurality of tofu doughs Tf for deep-fried tofu are conveyed to the first Y-direction conveyor 18 by the X-direction driving section 83 of the first cutting section 22. Thereafter, by adjusting the conveying speeds of the first Y-direction conveyor 18 and the second Y-direction conveyor 19, the plurality of tofu doughs Tf for deep-fried tofu are conveyed onto the second Y-direction conveyor 19 while being distributed with an increased interval in the Y-direction.

The composite cutting blade 25 in the first embodiment may be provided with the corner portion cutting blade 24 at least at one end portion of the longitudinal cutting blade 23, and has an aspect of cutting diagonal corner portions of the tofu dough ((b) and (d) of FIG. 9).

### Second Embodiment

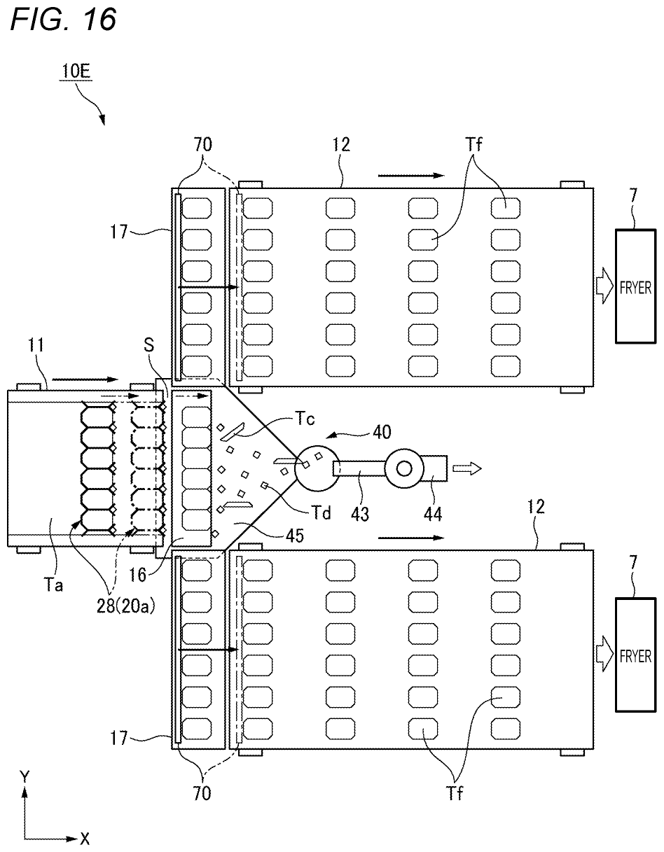

Next, a tofu dough cutter/feeder/supplier 10E according to a second embodiment will be described with reference to FIGS. 16 and 17. Equivalent components as those in the first embodiment are denoted by the same or corresponding reference numerals, and a description thereof is omitted.

In the cutter/feeder/supplier 10E of the second embodiment, as illustrated in FIG. 17, a cutting section 20a includes a composite cutting blade 28 in which the lateral cutting blade 21, the longitudinal cutting blades 23 and the corner portion cutting blades 24 are integrated. The lateral cutting blade 21 cuts the sheet-shaped tofu dough Ta in a direction perpendicular to the conveying direction of the tofu dough. The longitudinal cutting blades 23 cut the tofu dough in the same direction as the conveying direction. The corner portion cutting blades 24 chamfer the corner portions. In the present embodiment, the lateral cutting blade 21 connects the tips of the Y-shaped blades joined to the upstream ends of the longitudinal cutting blades 23, which are the corner portion cutting blades 24, in the Y direction. On the other hand, the Y-shaped blades joined to the downstream ends of the longitudinal cutting blades 23, which are the corner portion cutting blades 24, are separated from each other.

The composite cutting blade 28 of the present embodiment is configured to be driven in the Z direction (up-down drive) and the X direction (back-forth drive), and conveys the tofu doughs Tf for deep-fried tofu to the transfer conveyor 16 after cutting. The transfer from the downstream side of the upstream conveyor 11 to the transfer conveyor 16 may be performed by using a pushing device (not illustrated).

The tofu doughs Tf for deep-fried tofu are alternately conveyed from the transfer conveyor 16 to the two transfer conveyors 17 on both sides in the Y direction by guide members (not illustrated), and are distributed at intervals in the Y direction. Thereafter, the tofu doughs Tf for deep-fried tofu are conveyed from the transfer conveyor 17 to the downstream conveyor 12 by the guide members 70 and fed to the fryer 7.

The offcut pieces Tc, Td are collected by the collection/recycle mechanism 40 provided below the gap portion S between the upstream conveyor 11 and the transfer conveyor 16 and the gap portion S between the transfer conveyors 16 and 17 to cover the gap portions S from below. In this case, the collection/recycle mechanism 40 is provided with the hopper 45 below the gap portions S, and the offcut pieces Tc, Td collected by the hopper 45 are fed to the cutting device 43 and the stirring/supplying device 44 as in the first embodiment. The offcut pieces Tc, Td may be discharged to the collection/recycle mechanism 40 by appropriately using an air-blowing unit in combination.

Other configurations and operations are the same as those of the first embodiment.

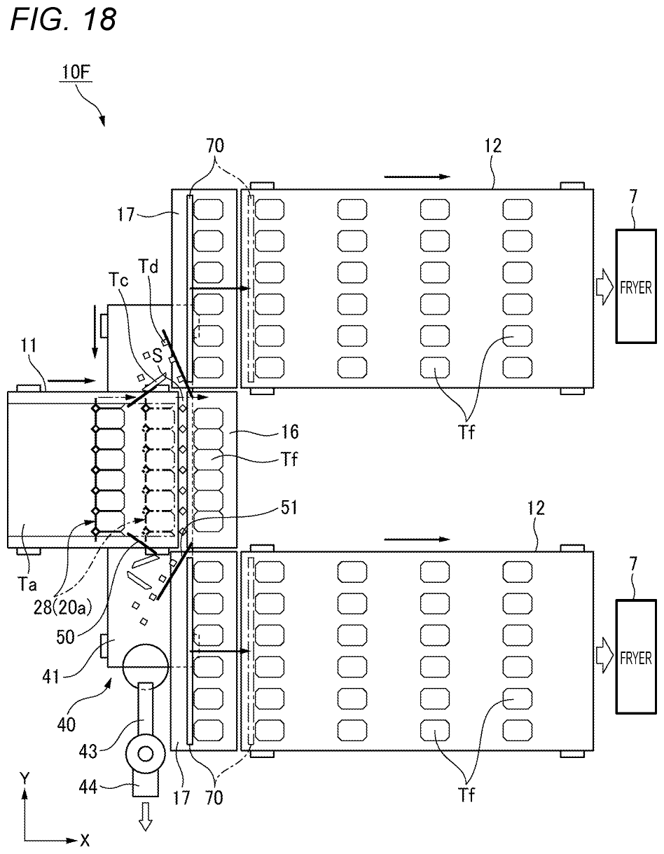

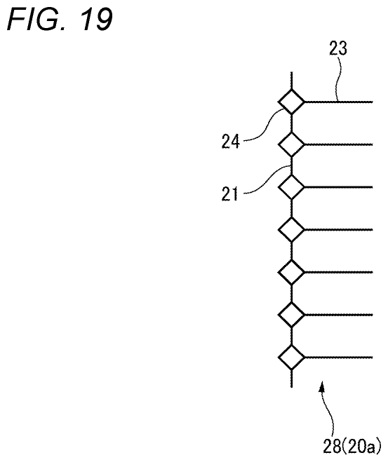

FIG. 18 shows a first modification of the tofu dough cutter/feeder/supplier according to the second embodiment. In the cutter/feeder/supplier 10F, as illustrated in FIG. 19, the composite cutting blade 28 is constituted by joining square pipe blades with holes as the corner portion cutting blades 24 to the upstream end portions of the longitudinal cutting blades 23, and joining the square pipe blades with holes with the lateral cutting blade 21.

In this case, after the sheet-shaped tofu dough Ta is cut into the tofu doughs Tf for deep-fried tofu by the composite cutting blade 28, the offcut pieces Td in the holes of the square pipe blade are not suctioned. When the square pipe blades are retracted upward, the offcut pieces Td are not entrained due to the air-blowing unit from the upper ends of the square pipe blades, and are transferred to the transfer conveyor 16. When transferred to the transfer conveyor 17, the offcut pieces Td are dropped downward, come into contact with the guide members 51, separated from the tofu doughs Tf, and are preferably dropped downward under the assistance of the air-blowing unit, conveyed on the collection conveyor 41, and collected and recycled by the collection/recycle mechanism 40. The air to be supplied to the air-blowing unit is preferably clean air or gas previously passed through an aseptic compressed air filter, a dehumidifier, or the like. The present invention does not use pressure reducing means or vacuum means because fine pieces of tofu dough and high-temperature and high-humidity air in the production room are also suctioned, and thus the inside of the air piping and the periphery of the suction member are unhygienic. When the air blowing and the air piping are used in common, dirty air may be taken in repeatedly, and a large amount of bacteria may be blown to the tofu dough or the offcuts of the tofu dough, which may cause secondary contamination.

FIG. 20 shows a second modification of the tofu dough cutter/feeder/supplier according to the second embodiment. In the cutter/feeder/supplier 10G, the sheet-shaped tofu dough Ta is cut into tofu doughs Tf for deep-fried tofu using the same composite cutting blade 28 as that of the first modification.

The offcut pieces that have entered the square pipe blades are blown out with clean air, left on the upstream conveyor 11 or the transfer conveyor 16, and dropped to the collection/recycle mechanism 40 below by an air-blowing unit or the like. Instead of blowing clean air, water vapor at about 100° C. may be blown. In any case, the inside of the square pipe blade is hygienic even during production.

In the present embodiment, when the tofu doughs Tf for deep-fried tofu are conveyed from the transfer conveyor 16 to the downstream conveyor 12, the tofu doughs Tf for deep-fried tofu are arranged on the downstream conveyor 12 in a zigzag manner by using a distribution mechanism (not illustrated). (Regarding the zigzag distribution, refer to FIG. 17 of JP2012-140158A and FIGS. 25 to 27 of JP2019-068809A.)

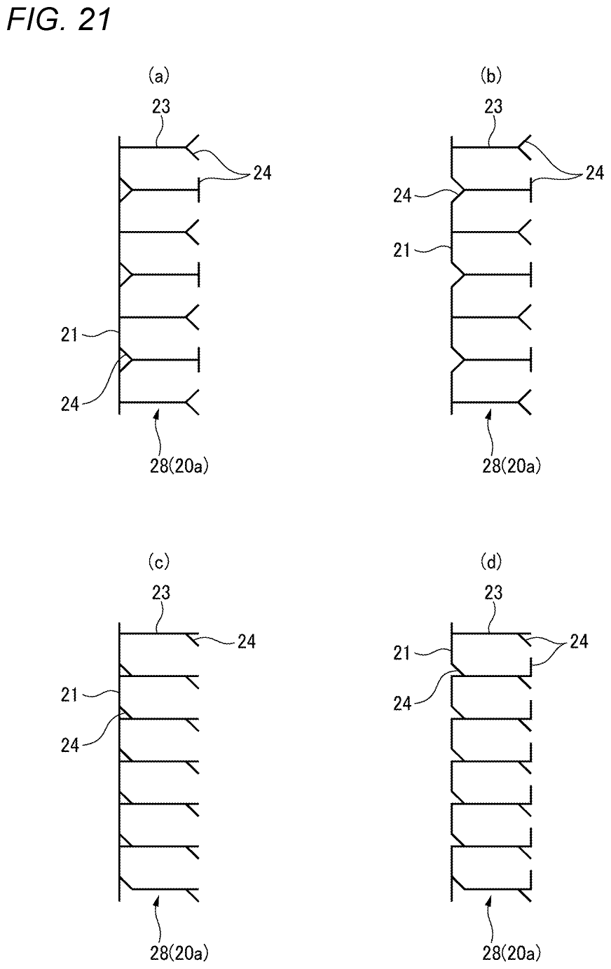

As the composite cutting blade 28 of the present embodiment, in addition to the above, a blade as illustrated in (a) to (d) of FIG. 21 may be applied. In (a) and (c) of FIG. 21, the composite cutting blade 28 has a cylindrical blade having a triangular prism shape with a substantially triangular cross section instead of the square pipe blade.

The present invention is not limited to the above embodiments, and modifications, improvements, and the like are possible as appropriate. In addition, a material, a shape, a dimension, a numerical value, a form, the number, a disposition position, and the like of each of components in the above embodiments are not limited as long as the present invention can be achieved.

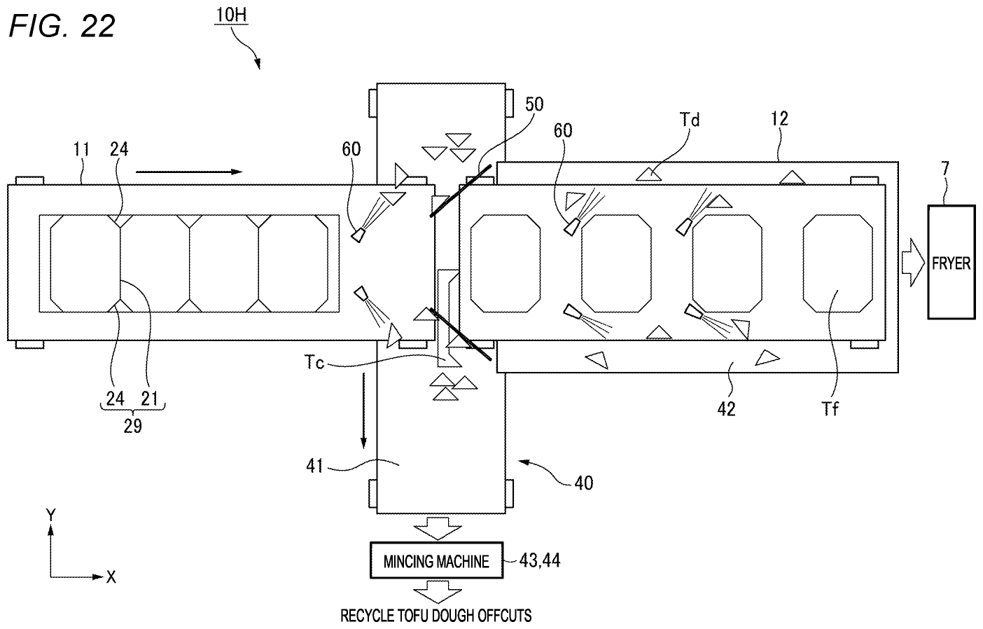

For example, the collection/recycle mechanism 40 of the present invention is also applicable to a system in which a tofu dough elongated in the X direction is cut into tofu doughs Tf for deep-fried tofu by a composite cutting blade 29 in which corner portion cutting blades 24 are joined to both end portions of a lateral cutting blade 21, as illustrated in a cutter/feeder/supplier 10H illustrated in FIG. 22.

The cutting device of the present embodiment includes the collection/recycle mechanism that catches, collects and recovers the offcut pieces generated when the tofu doughs for deep-fried tofu are cut out from the sheet-shaped tofu dough, but the cutting device of the present invention may be configured to include at least a collection mechanism that catches and collects the offcut pieces.

The present application is based on Japanese Patent Application No. 2020-136999 filed on Aug. 14, 2020, the contents of which are incorporated herein by reference.

### REFERENCE SIGNS LIST

10: cutter/feeder/supplier (cutting device)

11: upstream conveyor (conveyor)

12: downstream conveyor (another conveyor)

20: cutting section

21: lateral cutting blade

22: first cutting section

23: longitudinal cutting blade

24: corner portion cutting blade

25, 28: composite cutting blade

40: collection/recycle mechanism (collection mechanism)

41: collection conveyor

45: hopper

50: guide member

60: air-blowing unit

1. A tofu dough cutting device for cutting out a substantially rectangular tofu dough for deep-fried tofu from a sheet-shaped tofu dough by chamfering a corner portion of the sheet-shaped tofu dough, the tofu dough cutting device comprising:
a cutting section comprising:
a first cutting section comprising a lateral cutting blade configured to cut the sheet-shaped tofu dough in a direction perpendicular to a conveying direction of the sheet-shaped tofu dough; and
a second cutting section comprising a composite cutting blade in which a longitudinal cutting blade and a corner portion cutting blade are integrated, the longitudinal cutting blade being configured to cut the tofu dough in a same direction as the conveying direction, the corner portion cutting blade being provided at least at one end portion of the longitudinal cutting blade and being configured to chamfer the corner portion.

2. A tofu dough cutting device for cutting out a substantially rectangular tofu dough for deep-fried tofu from a sheet-shaped tofu dough by chamfering a corner portion of the sheet-shaped tofu dough, the tofu dough cutting device comprising:
a cutting section comprising a composite cutting blade in which a lateral cutting blade, a longitudinal cutting blade and a corner portion cutting blade are integrated, the lateral cutting blade being configured to cut the sheet-shaped tofu dough in a direction perpendicular to a conveying direction of the sheet-shaped tofu dough, the longitudinal cutting blade being configured to cut the tofu dough in a same direction as the conveying direction, the corner portion cutting blade being configured to chamfer the corner portion.

3. The tofu dough cutting device according to claim 1, further comprising:
a first member comprising a first conveyor or a first transfer plate, the first member being configured to receive the composite cutting blade;
a second member comprising a second conveyor or a second transfer plate, the second member being provided adjacent to and downstream of the first member; and
a collection mechanism provided below a gap portion between the first member and the second member to cover at least the gap portion, the collection mechanism being configured to catch and collect an offcut piece generated when the tofu dough for deep-fried tofu is cut out from the sheet-shaped tofu dough.

4. The tofu dough cutting device according to claim 3, further comprising:
an air-blowing unit provided above at least one of the second member or a downstream side of the composite cutting blade of the first member, and configured to drop the offcut piece downward toward the collection mechanism.

5. The tofu dough cutting device according to claim 3, further comprising:
a guide member provided on both side portions of the first member in a width direction and downstream of the composite cutting blade, the guide member being configured to drop the offcut piece downward toward the collection mechanism.

6. The tofu dough cutting device according to claim 1, further comprising:
a conveyor configured to convey the sheet-shaped tofu dough;
a chopping board section provided adjacent to and downstream of the conveyor and configured to receive at least the composite cutting blade of the cutting section, the chopping board section having a through hole corresponding to a shape of an offcut piece generated when the substantially rectangular tofu dough is cut out from the sheet-shaped tofu dough; and
a collection mechanism provided below the chopping board section and configured to collect the offcut piece.

7. The tofu dough cutting device according to claim 6,
wherein the second cutting section comprises a punching pin provided at a position corresponding to a position of the corner portion cutting blade and configured to discharge the offcut piece to the collection mechanism in conjunction with the corner portion cutting blade cutting the corner portion of the tofu dough.

8. The tofu dough cutting device according to claim 2, further comprising:
a conveyor configured to convey the sheet-shaped tofu dough;
a chopping board section provided adjacent to and downstream of the conveyor and configured to receive at least the composite cutting blade of the cutting section, the chopping board section having a through hole corresponding to a shape of an offcut piece generated when the substantially rectangular tofu dough is cut out from the sheet-shaped tofu dough; and
a collection mechanism provided below the chopping board section and configured to collect the offcut piece.

9. A tofu dough cutting device for cutting out a substantially rectangular tofu dough for deep-fried tofu from a sheet-shaped tofu dough by chamfering a corner portion of the sheet-shaped tofu dough, the tofu dough cutting device comprising:
a cutting section comprising:
a lateral cutting blade configured to cut the sheet-shaped tofu dough in a direction perpendicular to a conveying direction of the tofu dough;
a longitudinal cutting blade configured to cut the tofu dough in a same direction as the conveying direction; and
a corner portion cutting blade configured to chamfer the corner portion;
a first member comprising a first conveyor or a first transfer plate, the first member being configured to receive at least the corner portion cutting blade;
a second member comprising a second conveyor or a second transfer plate, the second member being provided adjacent to and downstream of the first member; and
a collection mechanism provided below a gap portion between the first member and the second member to cover at least the gap portion, the collection mechanism being configured to collect an offcut piece generated when the tofu dough for deep-fried tofu is cut out from the sheet-shaped tofu dough.

10. A method for producing deep-fried tofu using the tofu dough cutting device according to claim 1, the method comprising:
producing a substantially rectangular tofu dough for deep-fried tofu, the tofu dough being cut out from a sheet-shaped tofu dough and having a chamfered corner portion.

11. A method for producing deep-fried tofu using the tofu dough cutting device according to claim 2, the method comprising:
producing a substantially rectangular tofu dough for deep-fried tofu, the tofu dough being cut out from a sheet-shaped tofu dough and having a chamfered corner portion.

12. A method for producing deep-fried tofu using the tofu dough cutting device according to claim 9, the method comprising:
producing a substantially rectangular tofu dough for deep-fried tofu, the tofu dough being cut out from a sheet-shaped tofu dough and having a chamfered corner portion.

13. The tofu dough cutting device according to claim 2, further comprising:
a first member comprising a first conveyor or a first transfer plate, the first member being configured to receive the composite cutting blade;
a second member comprising a second conveyor or a second transfer plate, the second member being provided adjacent to and downstream of the first member; and
a collection mechanism provided below a gap portion between the first member and the second member to cover at least the gap portion, the collection mechanism being configured to catch and collect an offcut piece generated when the tofu dough for deep-fried tofu is cut out from the sheet-shaped tofu dough.

14. The tofu dough cutting device according to claim 13, further comprising:
an air blower provided above at least one of the second member or a downstream side of the composite cutting blade of the first member, and configured to drop the offcut piece downward toward the collection mechanism.

15. The tofu dough cutting device according to claim 13, further comprising:
a guide member provided on both side portions of the first member in a width direction and downstream of the composite cutting blade, the guide member being configured to drop the offcut piece downward toward the collection mechanism.
